(19) United States
(12) Patent Application Publication
(10) Pub. No.: US 2013/0317950 A1
(43) Pub. Date: Nov. 28, 2013

(54) CUSTOMIZING A THREE DIMENSIONAL VIRTUAL STORE BASED ON USER SHOPPING BEHAVIOR

(71) Applicants: SUBIL M. ABRAHAM, PLANO, TX (US); RAJARAMAN HARIHARAN, BANGALORE (IN); RAMAKRISHNAN KANNAN, BANGALORE (IN); MATHEWS THOMAS, FLOWER MOUND, TX (US)

(72) Inventors: SUBIL M. ABRAHAM, PLANO, TX (US); RAJARAMAN HARIHARAN, BANGALORE (IN); RAMAKRISHNAN KANNAN, BANGALORE (IN); MATHEWS THOMAS, FLOWER MOUND, TX (US)

(73) Assignee: INTERNATIONAL BUSINESS MACHINES CORPORATION, ARMONK, NY (US)

(21) Appl. No.: 13/478,627

(22) Filed: May 23, 2012

(51) Int. Cl. G06Q 30/06

(52) U.S. Cl. 705/27.1

(57) ABSTRACT

A planogram associated with a physical store can be identified. The physical store can be associated with an inventory. A virtual store comprising of a layout can be created. The virtual store can be a three dimensional environment permitting electronic commerce transactions. The layout of the virtual store and the planogram of the physical store can be identical. The layout can be a position or an orientation of an inventory item associated with the physical store inventory. The virtual store can be customized based on a personalization data. The customization can be an inventory item position and an orientation. The layout of the customized virtual store can be different from the planogram of the physical store.

### BACKGROUND

The present invention relates to the field of electronic commerce and, more particularly, to customizing a three dimensional virtual store based on user shopping behavior.

Today, shoppers are more discerning than ever before. It is necessary for retailers to provide an enhanced shopping experience for the customer that allows the customer to find the right product at the right place at the right price. The presentation of merchandise in the store plays a major role in improving the profitability of the stores and providing a highly tailored shopping experience for the consumer. Hence, most retailers adopt a space planning approach that is based on local customer insight and buying behavior using historical sales and performance data. However this approach is becoming less effective as consumers grow more tech savvy and develop distinct shopping patterns that are unique and different from others.

It is therefore necessary for physical, land-based stores to provide a personalized consumer experience rather than a more generic experience (e.g., one based on local demographics.) However, this currently presents a major challenge today for land-based storefronts. The online electronic commerce store provides a shopping experience that is very different from the physical store experience. That is, e-commerce stores do not have space planning strategies or planograms to address this issue.

### BRIEF SUMMARY

One aspect of the present invention can include a system, an apparatus, a computer program product, and a method for customizing a three dimensional virtual store based on user shopping behavior. A planogram associated with a physical store can be identified. The physical store can be a land-based storefront. The physical store can be associated with an inventory. A virtual store comprising of a layout can be created. The virtual store can be a three dimensional environment permitting electronic commerce transactions. The layout of the virtual store and the planogram of the physical store can be identical. The layout can be a position or an orientation of an inventory item associated with the physical store inventory. The virtual store can be customized based on a personalization data. The customization can be an inventory item position and an orientation. The layout of the customized virtual store can be different from the planogram of the physical store.

Another aspect of the present invention can include a method, an apparatus, a computer program product, and a system for customizing a three dimensional virtual store based on user shopping behavior. A personalization engine associated with an electronic commerce server can personalize a virtual store. The virtual store can be associated with a layout. The virtual store can be associated with a physical store. The physical store can be associated with a planogram and an inventory. The planogram and the layout can be identical. A data store can be configured to persist the virtual store, the layout, personalization data, and the planogram.

Yet another aspect of the present invention can include a system, an apparatus, a computer program product, and a method for customizing a three dimensional virtual store based on user shopping behavior. A virtual store which can include a layout. The virtual store can be a three dimensional environment permitting electronic commerce transactions. The layout of the virtual store can be identical to a planogram of an associated physical store. The layout can be at a position and an orientation of an inventory item associated with an inventory of the physical store. The virtual store can be customized based on a personalization data. The personalization data can be an inventory item position and orientation. The layout of the customized virtual store can be different from the planogram of the physical store.

### BRIEF DESCRIPTION OF THE SEVERAL VIEWS OF THE DRAWINGS

FIG. 1 is a schematic diagram illustrating a set of scenarios for customizing a three dimensional virtual store based on user shopping behavior in accordance with an embodiment of the inventive arrangements disclosed herein.

FIG. 2 is a schematic diagram illustrating a method for customizing a three dimensional virtual store based on user shopping behavior in accordance with an embodiment of the inventive arrangements disclosed herein.

FIG. 3 is a schematic diagram illustrating a system for customizing a three dimensional virtual store based on user shopping behavior in accordance with an embodiment of the inventive arrangements disclosed herein.

FIG. 4 is a schematic diagram illustrating a scenario and architecture for customizing a three dimensional virtual store based on user shopping behavior in accordance with an embodiment of the inventive arrangements disclosed herein.

FIG. 5 is a schematic diagram illustrating a method for customizing a three dimensional virtual store based on user shopping behavior in accordance with an embodiment of the inventive arrangements disclosed herein.

### DETAILED DESCRIPTION

The present disclosure is a solution for customizing a three dimensional virtual store based on user shopping behavior. In the solution, a physical store planogram can be virtualized to create a virtual planogram. The planogram can be utilized to model a three dimensional online electronic commerce virtual store based on the physical store.

That is, the layout of the virtual store is dependent on the planogram. The layout can be modified with the application of personalization data (e.g., purchases, returns, etc.) collected from a shopper. In this way, many different logical views of the virtual store can be created, permitting customization of the virtual store for the shopper. For example, if a shopper purchases coffee and creamer each time they shop, the layout of the virtual store can be configured to place the creamer next to the coffee. In one instance, customization can be analyzed to improve physical store planogram. In one embodiment, shoppers can share virtual stores and/or layouts permitting collaborative shopping experiences.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction processing system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction processing system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

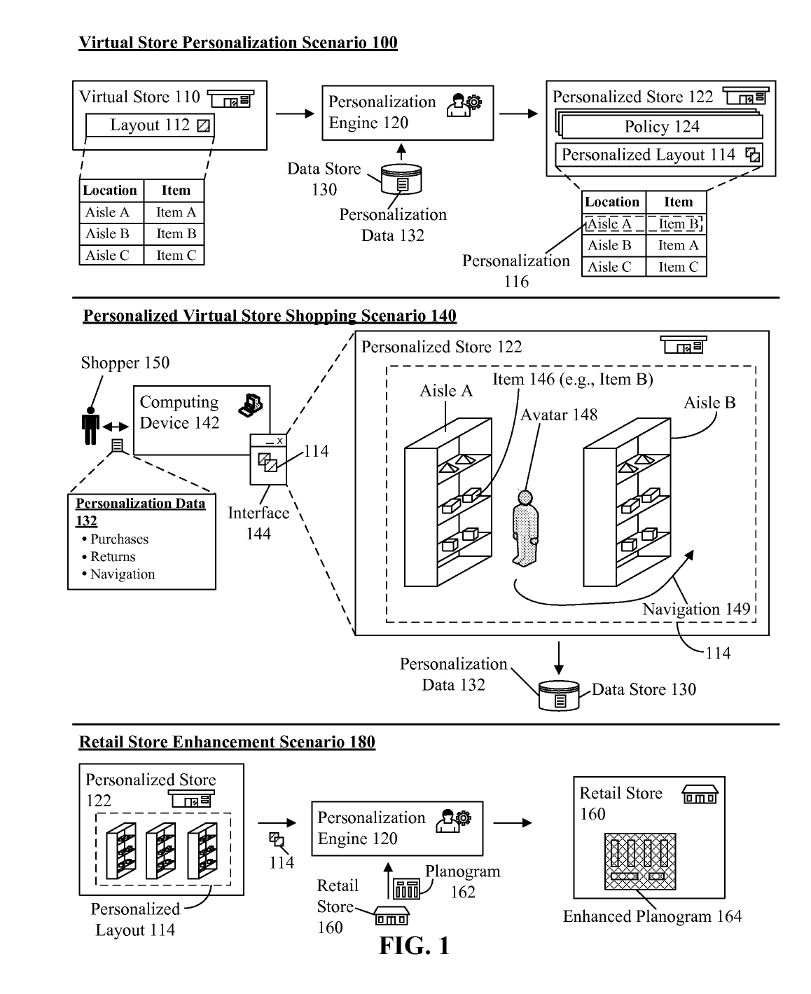

FIG. 1 is a schematic diagram illustrating a set of scenarios 100, 140, 180 for customizing a three dimensional virtual store based on user shopping behavior 100 in accordance with an embodiment of the inventive arrangements disclosed herein. Scenario 100, 140, 180 can be present in the context of method 200, system 300, scenario 400, architecture 460, and/or method 500. In scenario 100, 140, 180, personalization data can be leveraged to improve online shopping within a three dimensional virtual store. In scenario 100, a virtual store 110 can be customized utilizing a personalization engine 120 and personalization data 132. The customization can yield a personalized store 122 with a personalized layout 114. That is, a personalized layout 114 of virtual store 110 can be generated for shopper 150, enable a personalized experience for the shopper 150. In scenario 140, the shopper can navigate the personalized store 122 in a traditional e-commerce manner using avatar 148 to interact with store 122 and items (e.g., item 146) within the store 122. In scenario 180, the personalized store and/or personalized layout 114 can be utilized to enhanced a retail store layout (e.g., enhanced planogram 164).

As used herein, virtual store 110 can be a three dimensional environment which can be modeled from retail store 160 planogram 162. For example, planogram 162 can be utilized to generate virtual store 110 layout 112. Planogram 162 can be a visual representation of a store 110 products and/or services. Planogram 162 can include, but is not limited to, item location information (e.g., aisle location, shelf number), inventory information (e.g., quantity), pricing information, service information (e.g., pharmacy, eye care, etc.), and the like. Personalized store 122 can be a logical view of virtual store 110. That is, multiple personalized stores 122 can be created for a shopper 150 without affecting virtual store 110 and/or layout 122. For example, a shopper can have two personalized stores 122, a store for collaborative shopping and a store for individual shopping. Personalized store 122 can include an avatar 148 which can represent a shopper 150 within store 122. That is, the avatar 148 can permit shopper 150 to interact within the three dimensional environment (e.g., store 122) in a traditional and/or proprietary manner. For example, avatar 148 can be controlled by a mouse and keyboard via device 142 enabling shopper 150 to use avatar 148 to navigate store 122 aisles.

In one embodiment, store 122 can be associated with a policy 124. In the embodiment, policy 124 can include rules, virtual store 110 preferences, virtual store 110 settings, user established preferences, and the like. For example, policy 124 can include a visibility/accessibility (e.g., public, and non-public) enabling a shopper to share the store 122 with other shoppers. It should be appreciated that store 122 can include multiple policies 124.

It should be appreciated that layout 112 can include three dimensional data, including, but not limited, three dimensional positioning, orientation, and the like. Layout 112 can include, but is not limited to, item name, item location (e.g., aisle), and the like. For example, layout 112 can include item 146 (e.g., Item B) location within the store 110 (e.g., Aisle B) and within the aisle shelf (e.g., second shelf). Personalized layout 114 can be a customization of layout 112 which can permit shopper specific configuration of the store 110. Personalized store 122 and corresponding personalized layout 114 can be presented within interface 144.

In virtual store personalization scenario 100, a virtual store 110 layout 112 can be personalized utilizing personalization data 132 stored in data store 130. Personalization data 132 can include, but is not limited to, shopper 150 purchases, shopper 150 returns, shopper 150 navigation, preferences, subscribed services, and the like. Personalized data 132 can be analyzed by engine 120 to determine relevant customizations to layout 112. Data 132 can be utilized to personalize layout 112 which can yield personalized layout 114. For example, Item B can be associated with a personalization 116 which can move item B from Aisle B to Aisle A.

In one instance, virtual store 122 layout 114 can be customized to accommodate shopper 150 behavior. In one configuration of the instance, based on navigation 149 trail created by avatar 148 in a previous e-commerce session, store 122 aisles can be customized. For example, store 122 aisles can be arranged to present favorite items at more prominently in layout 114 than in layout 112. In another configuration, personalized layout 114 can include a “favorites” aisle which can include shopper 150 favorite items (e.g., cereals, coffee, cookies). In one instance, based on shopper 140 historic purchases, layout 114 can be modified to cross sell and/or upsell items.

In personalized virtual store shopping scenario 140, a shopper 150 can utilize a computing device 142 to shop within the virtual store 122 during an e-commerce session. E-commerce session can be a semi-permanent interactive information interchange between two or more computing devices 142 to perform buying and selling of products or services over electronic systems. It should be appreciated that session can be a part of a traditional e-commerce session (e.g., E-commerce Website).

Layout 114 can be presented within interface 144 which can enable shopper 150 to interact with personalized store 122. Shopper 150 can control avatar 148 to perform e-commerce transactions (e.g., purchasing items) during the session. As user performs e-commerce transactions, personalization data 132 can be collected and stored within data store 130. For example, if shopper 148 purchases item 146, information about item 146 can be collected and analyzed to improve personalized layout 114 in subsequent sessions.

In retail store enhancement scenario 180, personalized layout 114 can be process by personalization engine 120 to improve retail store 160 planogram (e.g., planogram 162). Planogram 162 can be associated with retail store 160 which can be conveyed to personalization engine 120. In one instance, personalization engine 120 can analyze layout 114 trends to determine commonalities between layouts which can be utilized to improve store 160 experience. In another instance, personalization engine 120 can utilize personalization data 132 associated with store 122 to determine shopper current interests. In the instance, engine 120 can determine items that are currently in demand from personalization data 132 and create enhanced planogram 164 to reflect the demand.

Drawings presented herein are for illustrative purposes only and should not be construed to limit the invention in any regard. It should be appreciated that the disclosure can support multiple personalized stores, multiple virtual stores, multiple retail stores, and the like. For example, each virtual store can be associated with a retail store location of a retail store chain. Personalization of store 122 can include, but is not limited to, horizontal product placement, vertical product placement, block product placement, and the like.

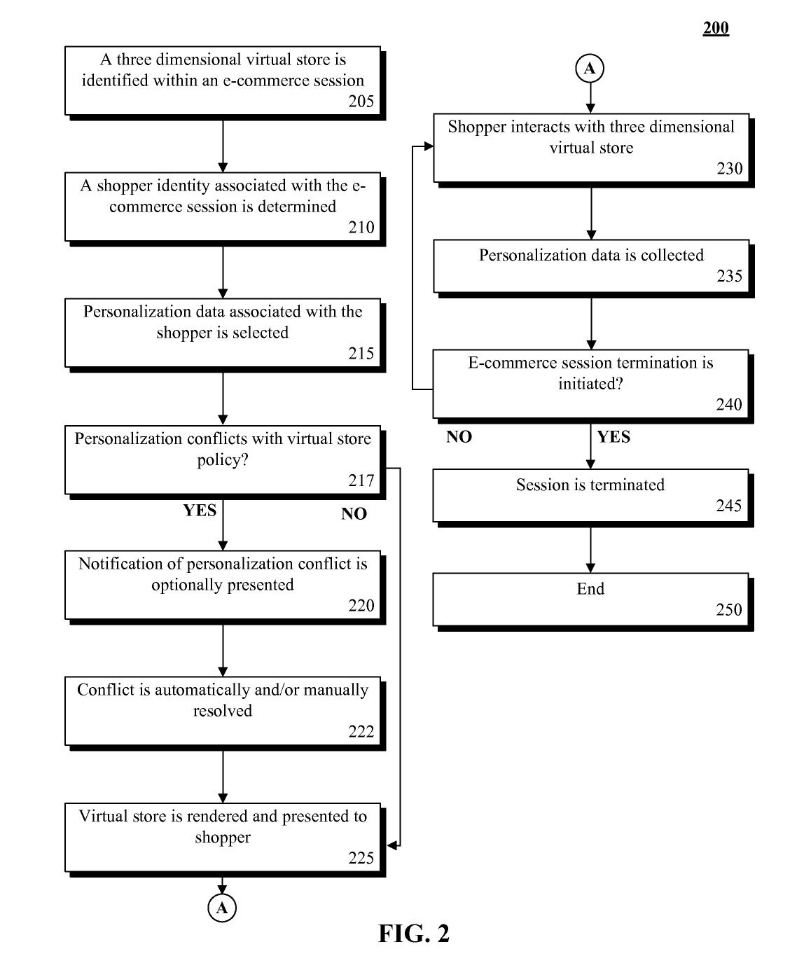

FIG. 2 is a schematic diagram illustrating a method 200 for customizing a three dimensional virtual store based on user shopping behavior in accordance with an embodiment of the inventive arrangements disclosed herein. Method 200 can be performed in the context of scenario 100, 140, 180, system 300, scenario 400, architecture 460, and/or method 500. In method 200, a three dimensional virtual store can be personalized utilizing personalization data. For example, personalization can include layout changes which can assist a shopper in finding frequently purchased items.

In step 205, a three dimensional virtual store can be identified within an en electronic commerce (e.g., e-commerce) session. The virtual store can be associated with a physical store or a Web site. For example, the virtual store can be associated with an online retailer Web-site (e.g., NEWEGG.COM). In one instance, the virtual store can be rendered within an application provided by a retailer. For instance, the virtual store a fully interactive environment which can be part of an ANDRIOD compatible application (e.g., mobile phone application).

In step 210 a shopper identity can be associated with the e-commerce session can be determined. The determination can be automatic and/or manual. For example, the shopper can log into a Web site prior to accessing the virtual store. Identity determination can be performed via one or more traditional and/or proprietary mechanisms. In step 215, personalization data associated with the shopper can be selected. For example, personalization data such as virtual store aisle arrangement preferences can be selected. It should be appreciated that a portion of personalization data can be utilized and all personalization data need not be used to create a personalized virtual store. In step 217, if personalization conflicts with virtual store policy, the method can continue to step 220, else proceed to step 225. Policy can include, but is not limited to, item position/orientation rules, aisle placement rules, affiliate rules, corporate rules, and the like.

In step 220, notification of personalization conflict can be optionally presented. The notification can be a visual and/or aural notification. For example, the notification can be pop-up dialog box indicating an aisle cannot be moved to a different location within the virtual store. The notification can be presented to a shopper, an administrator of the virtual store, and the like. In step 222, the conflict can be manually and/or automatically resolved based on one or more rules. In one instance, rules associated with virtual store policy can be utilized to determine resolution outcomes. For example, if an affiliate of the virtual store pays to place an item in virtual store Aisle A, a policy can be used to resolve a conflict when a shopper attempts to relocate the item to Aisle B. That is, a notification can be presenting indicating the item cannot be relocated.

In step 225, the virtual store can be rendered and presented to the shopper. In one embodiment, the virtual store can be presented on a three dimensional capable device. For example, the virtual store can be displayed on a 3D television. In step 230, the shopper can interact with the three dimensional virtual store. Interaction can include inviting other shoppers into the shopper personalized store, utilizing store services (e.g., pharmacy service), and the like. In step 235, personalization data can be collected. Data 235 can be collected in one or more proprietary and/or traditional ways. In one instance, a filter can be utilized to determine which personalization data to collect. For example, a navigation filter can be used to collect only shopper navigation path information to determine shopper browsing patterns. In step 240, if the e-commerce session termination is received, the method can continue to step 245, else return to step 230. Steps 230-240 can be continuously performed for the duration of the e-commerce session, enabling personalization data to be perpetually collected. In step 245, the session can be terminated. Termination can include, but is not limited to, storing virtual store customizations performed during the session, persisting avatar location, and the like. In step 250, the method can end.

Drawings presented herein are for illustrative purposes only and should not be construed to limit the invention in any regard. Method 200 can be performed in parallel and/or serial. It should be appreciated that the method can be performed in real-time or near real-time. It should be understood that the method can be performed for a shopper shopping within a different shopper's personalized store.

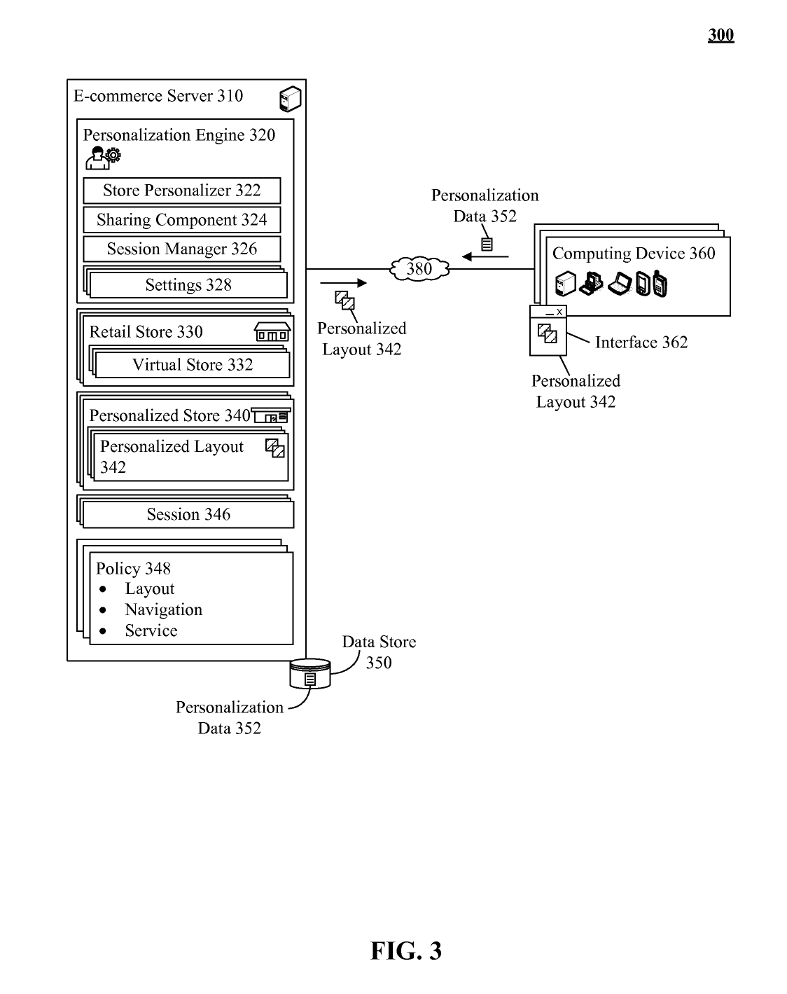

FIG. 3 is a schematic diagram illustrating a system 300 for customizing a three dimensional virtual store based on user shopping behavior in accordance with an embodiment of the inventive arrangements disclosed herein. System 300 can be present in the context of scenario 100, 140, 180 and/or method 200, scenario 400, architecture 460, and/or method 500. In system 300, a personalization engine 320 can automatically customize a three dimensional virtual store 332 associated with a retail store 330. The customization can be presented in the form of a personalized layout 342 within a personalized store 340. For example, personalized layout 342 can be a personalized three dimensional model of store 340 contents (e.g., aisles, items, etc.). It should be appreciated that system 300 can represent one embodiment of the disclosure and should not be construed to limit the invention in any regard. In one embodiment, system 300 can be a component of a Service Oriented Architecture. System 300 components can be communicatively linked via one or more networks 380.

E-commerce server 310 can be a hardware/software entity for executing personalization engine 320. Server 310 can include, but is not limited to, personalization engine 320, retail store 330 data, personalized store 340 data, session 346 data, policy 348 data, data store 350, and the like. Server 310 functionality can include, but is not limited to, session 346 hosting, file serving, Web services, and the like. In one embodiment, server 310 can be an IBM WEBSPHERE COMMERCE server.

Personalization engine 320 can be a hardware/software element for personalizing a virtual store 340. Engine 320 can include, but is not limited to, store personalizer 320, sharing component 324, session manager 326, settings 328, and the like. Engine 320 functionality can include, but is not limited to, security management, encryption, shopper registration, and the like. In one instance, engine 320 can be a networked computing element. It should be appreciated that one or more components of engine 320 can be omitted providing that engine 320 functionality is maintained. In one embodiment, engine 320 can be a component of an IBM WEBSPHERE COMMERCE server.

Store personalizer 322 can be a hardware/software component for collecting, and/or analyzing personalization data 352 associated with session 346. Personalizer 322 functionality can include, but is not limited to, policy conflict resolution, layout 342 management, store 340 management, store 330, 332 selection, and the like. In one embodiment, personalizer 322 can perform automatic conflict resolution when a personalization conflicts with policy 348. In another embodiment, personalizer 322 can enable manual conflict resolution permitting granular control of policy 348 application.

Sharing component 324 can be a hardware/software element for sharing store 340 and/or personalized layout 342. Component 324 functionality can include, but is not limited to, layout 342 sharing management, personalization data 352 sharing, and the like. In one embodiment, shopper 352 can leverage controls over personalization data 352 sharing. In the embodiment, shopper 352 can limit collection and/or dissemination of personalization data from one or more entities. For example, a shopper can restrict personalization data from being utilized by third party entities (e.g., affiliates, etc.). In one embodiment, component 324 can facilitate the real-time sharing of personalized store 340. In the embodiment, component 324 can permit collaborative shopping across physical (e.g., retail store 330) and virtual stores (e.g., personalized store 340), group view of a personalized store 340, and the like. In one configuration of the embodiment, a shopper interacting with a personalized store 340 can communicate with another shopper in a retail store 330. For example, the shopper can obtain other shopper's opinion or feedback on certain products on a real-time basis.

Another functionality provided by the disclosure can include physical store presence awareness. For example, a shopper of the personalized store 340 can be aware of the presence of a physical consumer in the retail store 330. In one embodiment, an avatar of a physical shopper can be projected into a personalized view of a shopper utilizing the personalized store 340. Similarly, the physical consumer can detect the presence of a shopper within a personalized store 340 by utilizing a shopping assistive device. Shopping assistive device can include, but is not limited to, a mobile phone (e.g., executing a shopping application), a personal shopping cart device fitted to a cart, a tablet device (e.g., with a view of a personalized store), and the like. For example, if a consumer is in Aisle 1 then the consumer can be alerted of any shoppers within a personalized store 340 shopping in Aisle 1. That is, the disclosure can provide the capability for shoppers to collaborate with each other real-time regardless of whether they are in the virtual realm or in the physical realm.

Session manager 326 can be a hardware/software component for maintaining session 346 and/or session 346 data. Manager 326 functionality can include, but is not limited to, session 346 initiation, session 346 termination, session 346 encryption, and the like. Manager 326 can be utilized to persist data between session 346, import/export data between sessions 346, and the like. In one embodiment, manager 326 can be utilized to view personalization data 352.

Settings 328 can be one or more options for configuring the behavior of system 300, server 310, and/or engine 320. Settings 328 can include, but is not limited to, store personalizer 322 settings, sharing component 324 options, session manager 326 settings, retail store 330 settings, virtual store 332 settings, store 340 options (e.g., user preferences), policy 348, and the like. In one instance, setting 328 can be automatically (e.g., heuristically) established. In one embodiment, settings 328 can be presented within interface 362 permitting manual configuration of settings 328.

Retail store 330 can be a physical establishment able to buy and/or sell products and/or services. Store 330 can include a department store, a discount store, a warehouse store, a specialty store, a general store, a convenience store, a supermarket, a hypermarket, a boutique, a kiosk, a mall, a pawn shop, a consignment shop, and the like. Store 330 can be associated with a planogram, a virtual store 332, and the like. Store 330 can include multiple stores (e.g., retail chain) which can be associated with unique store identifiers. Each store identifier can be linked to virtual store 332 enabling multiple virtual stores 332 which can represent the retail store 330 within an electronic commerce session. In one instance, as store 330 changes (e.g., products are added/removed), virtual store 332 can change. In the instance, engine 320 can propagate store 330 changes to personalized layout 342. In one configuration of the instance, notifications of store 330 changes can be presented to a shopper to alert the shopper of layout 342 changes.

Session 346 can be a real-time electronic commerce session associated with personalized store 340. Session 346 can be initiated automatically and/or manually. Session 346 can support multiple shoppers each utilizing a computing device 360 to interact with a personalized store 340. Session 346 data can be persisted in a traditional and/or proprietary manner. For example, session 346 data can be stored within a Web browser cookie.

Policy 348 can be a set of rules for managing store 340 functionality and/or appearance. Policy 348 can include, but is not limited to, layout rules, navigation rules, service rules, and the like. In one embodiment, policy 348 can be automatically determined based on store 330 and/or virtual store 332 rules. In another embodiment, policy 348 can be manually established and/or maintained by an administrative entity.

Data store 350 can be a hardware/software component able to persist personalization data 352, settings 328, store 330 data, virtual store 332 data, store 340, personalized layout 342, and the like. Data store 350 can be a Storage Area Network (SAN), Network Attached Storage (NAS), and the like. Data store 350 can conform to a relational database management system (RDBMS), object oriented database management system (OODBMS), and the like. Data store 350 can be communicatively linked to server 310 in one or more traditional and/or proprietary mechanisms. In one instance, data store 350 can be a component of Structured Query Language (SQL) complaint database.

Personalization data 352 can be a data set associated with a shopper, a store 340, and the like. Data 352 can include, but is not limited to, shopper biometrics, shopper preferences associated with device 360, and the like. For example, data 352 can include store 340 color, store 340 graphic resolution (e.g., display width/height), and the like. Data 352 can conform to one or more traditional and/or proprietary formats. In one instance, data 352 can be one or more tables within a database.

Computing device 360 can be a software/hardware element for executing session 346, presenting store 340 and/or layout 342. Device 360 can include, but is not limited to, interface 362, input components, output components, and the like. In one instance, device 360 can be a three dimensional (3D) capable device. Device 360 hardware can include, but is not limited to, a processor, a non-volatile memory, a volatile memory, a bus, and the like. Computing device 360 can include, but is not limited to, a desktop computer, a laptop computer, a mobile phone, a mobile computing device, a portable media player, a PDA, and the like.

Interface 362 can be a user interactive component permitting interaction with store 340 and/or layout 342. Interface 362 can be present within the context of an administrative interface, a Web browser application, a rich internet application (RIA), and the like. Interface 362 capabilities can include a graphical user interface (GUI), voice user interface (VUI), mixed-mode interface, and the like. Interface 362 can be communicatively linked to device 360 by one or more traditional and/or proprietary mechanisms.

Network 380 can be an electrical and/or computer network connecting one or more system 300 components. Network 380 can include, but is not limited to, twisted pair cabling, optical fiber, coaxial cable, and the like. Network 380 can include any combination of wired and/or wireless components. Network 380 topologies can include, but is not limited to, bus, star, mesh, and the like. Network 380 types can include, but is not limited to, Local Area Network (LAN), Wide Area Network (WAN), VPN and the like.

Drawings presented herein are for illustrative purposes only and should not be construed to limit the invention in any regard. In one embodiment, system 300 can be a component of a distributed computing environment, a networked computing environment, and the like. It should be appreciated that one or more components can be optionally omitted providing that system 300 functionality is retained.

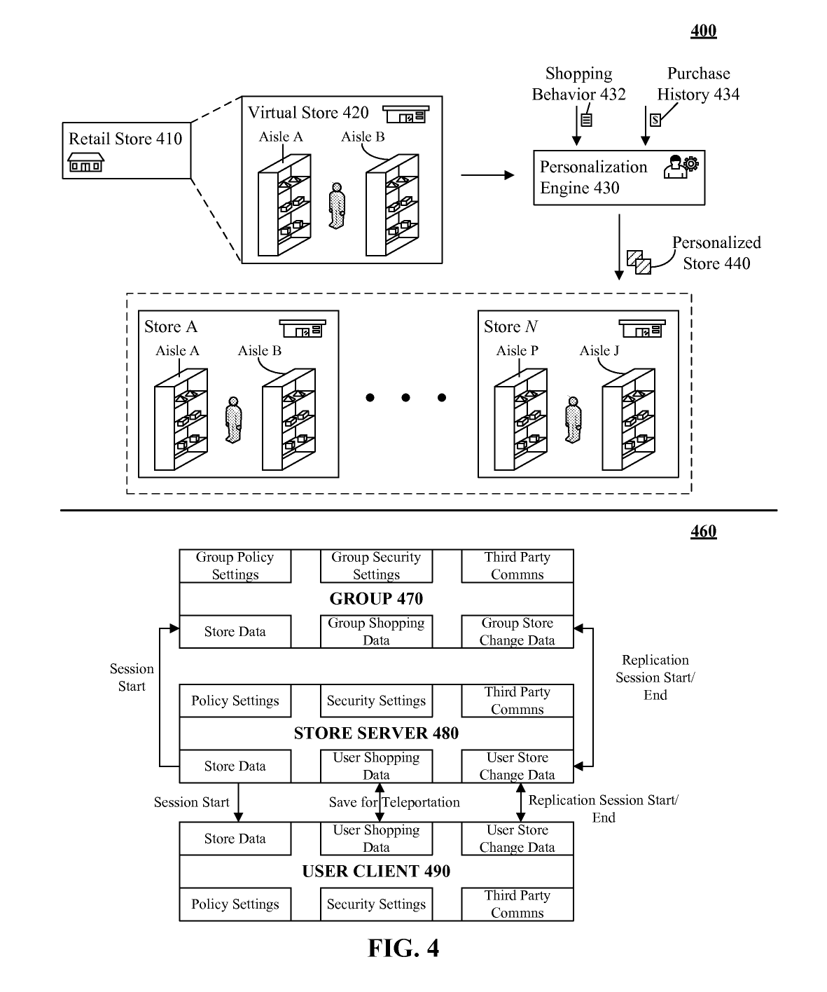

FIG. 4 is a schematic diagram illustrating a scenario 400 and architecture 460 for customizing a three dimensional virtual store based on user shopping behavior in accordance with an embodiment of the inventive arrangements disclosed herein. Scenario 400 and architecture 460 can be present within the context of scenario 100, 140, 180, method 200, system 300, and/or method 500.

In scenario 400, retail store 410 can be virtualized as a virtual store 420 which can be a three dimensional (3D) store. The virtual store 420 can be customized based on the shopping behavior 432 of the registered shopper. In other words, the retail store 410 can be personalized for each individual shopper who chooses to shop at the store using his/her online avatar. Using personalization engine 430 (e.g., predictive analytics tools), the retailer (e.g., retail store 410 owner) can analyze the shopping behavior 432 and/or shopping history 434 to produce personalized stores 440. That is, a shopper can have individualized stores based on shopping habits.

In architecture 460, a group 470, store server 480, and user client 490 can be utilized to permit the disclosed functionality. Every shopper session can the following data including, but not limited to server/store enforced rules, retail store planogram, the number of aisles, departments in the stores (e.g., grocery, electronics, home appliances etc.), and the like. It should be appreciated that the shopper cannot change this data. Other shopper modifiable data can include, user specific data such as shopping data (e.g., cart items etc.), items that can be rearranged in the shelves, and the like. Finally the user specific data can be replicated to the server, so that during a subsequent login data can be populated to reflect the previous visit. For example, when the user logs on for the first time, his shelves and aisles can be arranged that meets the shopper preferences. The objective of the arrangement can be such that the shopper should be making minimal changes. Such an objective can be met by performing the arrangement based on the learning from various parameters such as proximate store location, similar arrangements such as friends, based on the past data, age, gender, nature of shopper personality, and the like. The shopper can enter the store for shopping with a virtual cart (e.g., virtual shopping cart). During shopping, the shopper can be presented with options to change the store to meet their taste. The shopper can be visibly notified on the changes that he is allowed to perform such as using color coding, messages, and the like. All changes and shopping activity in the session can be saved and tracked. At the end of the session the shopper can check out the items in the store. When the session is terminated, the shopper can be prompted to save changes to the next session.

It should be appreciated that in the session, the shopper can include a group of shoppers such as family, friends, and the like. In such a scenario, the store will be arranged in such a way as to reduce the total differences among the group of shoppers. For example, the objective in the group view is such that the number of changes by the individuals in the groups will be minimum from the initial arrangements. That is, the group characteristics are not just the aggregation of the individual preferences. In one instance, shoppers in a group can choose to either have a separate carts or a group cart. If the shopper selects separate carts, the personalization data can be captured as individual shopping behavior in a particular group. Similarly at the end of the session, the store level changes can be recorded as the group behavior. These changes can be appropriately reflected when the group shops again together. Alternatively, the abstractions of these changes can be captured and reflected appropriately.

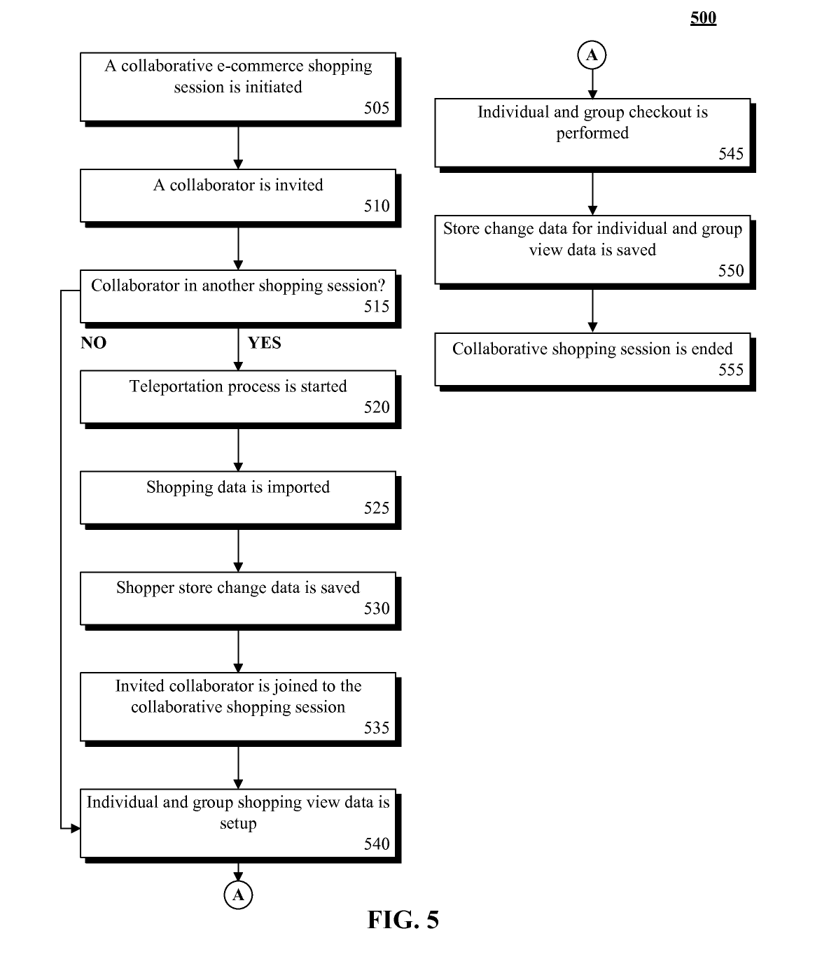

FIG. 5 is a schematic diagram illustrating a method 500 for customizing a three dimensional virtual store based on user shopping behavior in accordance with an embodiment of the inventive arrangements disclosed herein. Method 500 can be present in the context of scenario 100, 140, 180, method 200, system 300, scenario 400, and/or architecture 460. In method 500, a collaborative shopping session can permit two or more shoppers to collaboratively shop the same personalized store.

In step 505, a collaborative e-commerce shopping session can be initiated. In step 510, a collaborator can be invited in a traditional or proprietary manner. For example, the collaborator can be invited by an email invite. In step 515, if the collaborator is present in another shopping session, the method can continue to step 515, else proceed to step 540. In step 520, a teleportation process can be started. In one instance, an avatar associated with the collaborator can be teleported into a personalized store associated with a shopper. In step 525, shopping data can be imported into the personalized store. In step 530, shopper store change data can be saved. In step 535, the invited collaborator can be joined to the collaborative shopping session. In step 540, individual and group shopping view data can be setup. In step 545, individual and group checkout can be performed. In step 550, store change data for individual and group view data can be saved. In step 555, the collaborative shopping session can be ended.

The flowchart and block diagrams in the FIGS. 1-5 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be run substantially concurrently, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for customization of a virtual store comprising:
identifying a planogram associated with a physical store, wherein the physical store is associated with an inventory;
creating a virtual store comprising of a layout, wherein the virtual store is a three dimensional environment permitting electronic commerce transactions, wherein the layout of the virtual store and the planogram of the physical store is identical, wherein the layout is at least one of a position and orientation of at least one inventory item associated with the physical store inventory; and
customizing the virtual store based on a personalization data, wherein the customization is at least one of an inventory item position and orientation, wherein the layout of the customized virtual store is different from the planogram of the physical store.

2. The method of claim 1, wherein the store is a retail store associated with an electronic commerce store, wherein the electronic commerce store comprises of least a portion of identical inventory of the retail store.

3. The method of claim 1, wherein the layout includes at least one of inventory information, pricing information, layout information, and service information.

4. The method of claim 1, wherein the customizing is performed automatically utilizing at least one of a historic purchase and a previously established shopper configuration setting.

5. The method of claim 1, wherein the customizing is the suppressing of item presentation within the virtual store.

6. The method of claim 1, further comprising:
disallowing a manipulation of an item, wherein the manipulation is at least one of a position and orientation modification; and
presenting a notification indicating the item cannot be manipulated.

7. The method of claim 1, wherein the customizations is analyzed to change the at least one of the position and orientation of an item within the physical store.

8. The method of claim 1, further comprising:
selecting a customized virtual planogram owned by a shopper; and
sharing the virtual store with a different shopper, wherein the different shopper interacts with the virtual store.

9. The method of claim 8, further comprising:
positioning the different shopper within the virtual store at a location determined by the shopper; and
the different shopper, navigating the virtual store simultaneously with the shopper.

10. The method of claim 8, wherein the
utilizing the personalization data to enhance the planogram organization.

11. The method of claim 1, further comprising:
determining a quantity of different shoppers visiting the virtual store owned by the shopper; and
automatically rewarding the shopper an appropriate reward based on the quantity of different shoppers visiting the virtual store.

12. A system for customizing of a virtual store comprising:
a personalization engine associated with an electronic commerce server able to personalize a virtual store, wherein the virtual store is associated with a layout, wherein the virtual store is associated with a physical store, wherein the physical store is associated with a planogram and an inventory, wherein the planogram and the layout is identical; and
a data store configured to persist at least one of the virtual store, the layout, personalization data, and the planogram.

13. The system of claim 12, further comprising:
a personalizer configured to manipulate at least one of a position or orientation of an inventory item within the virtual store;
a sharing component able to permit simultaneous shopping within a virtual store, wherein the simultaneous shopping comprises of a shopper interaction and a different shopper interaction, wherein the shopper interaction and the different shopper interaction are separate e-commerce transactions; and
a session manager configured to persist personalization between sessions.

14. The system of claim 12, wherein the layout is associated with policy settings, wherein the policy settings permit or deny item manipulation within the virtual store.

15. The system of claim 12, wherein the sharing component is configured to dynamically position a different shopper within a virtual store at a location determined by the shopper, wherein the virtual store is owned by the shopper.

16. The system of claim 12, further comprising:
a predictive analyzer able to automatically configure the virtual store based on at least one of a shopping behavior and a purchase history associated with the shopper.

17. The system of claim 16, wherein the planogram is modified based on at least one of the shopping behavior and the purchase history.

18. A method for customizing a virtual store comprising:
identifying a virtual store comprising of a layout, wherein the virtual store is a three dimensional environment permitting electronic commerce transactions, wherein the layout of the virtual store is identical to a planogram of an associated physical store, wherein the layout is at least one of a position and orientation of at least one inventory item associated with an inventory of the physical store; and
customizing the virtual store based on a personalization data, wherein the personalization data is at least one of an inventory item position and orientation, wherein the layout of the customized virtual store is different from the planogram of the physical store.

19. The method of claim 18, further comprising:
disallowing a manipulation of an item, wherein the manipulation is at least one of a position and orientation modification; and
presenting a notification indicating the item cannot be manipulated.

20. The method of claim 18, wherein the customizing is performed automatically utilizing at least one of a historic purchase and a previously established shopper configuration setting.
